(19) United States
(12) Patent Application Publication
(10) Pub. No.: US 2015/0145779 A1
(43) Pub. Date: May 28, 2015

(54) Image Display Apparatus And Image Display Method

(71) Applicant: KONICA MINOLTA, INC., Chiyoda-ku (JP)

(72) Inventor: Youko KOUDA, Hachioji-shi (JP)

(73) Assignee: KONICA MINOLTA, INC., Chiyoda-ku (JP)

(21) Appl. No.: 14/550,366

(22) Filed: Nov. 21, 2014

(30) Foreign Application Priority Data
Nov. 22, 2013 (JP) 2013-241431

(51) Int. Cl. G09G 5/00; G06F 3/0354; G06F 3/023; G06F 19/00

(52) U.S. Cl. CPC G09G 5/003; G06F 19/321; G06F 3/03548; G06F 3/023; G09G 2380/08; G09G 2354/00; G09G 2320/10
USPC 345/168; 345/156; 345/184; 345/501

(57) ABSTRACT

An image display apparatus includes: a display unit configured to display an original image and a processed image obtained by applying image processing to the original image so that a lesion that is unidentifiable owing to a bone can be identified; an operation unit configured to receive an operation performed by a user; and a control unit configured to switch display on the display unit to the processed image when one operation at the operation unit is detected in a state in which the original image is displayed on the display unit, and switch the display on the display unit to the original image when the one operation at the operation unit is detected in a state in which the processed image is displayed on the display unit.

The entire disclosure of Japanese Patent Application No. 2013-241431 filed on Nov. 22, 2013 including description, claims, drawings, and abstract are incorporated herein by reference in its entirety.

### BACKGROUND OF THE INVENTION

1. Field of the Invention

The present invention relates to an image display apparatus and an image display method.

2. Description of the Related Art

In recent years, in the field of medicine, medical imaging such as CR (Computed Radiography), DR (Digital Radiography), and CT (Computed Tomography) has been increasingly digitized. Since a lesion may be overlooked when bone tissue and the lesion overlap with each other in a medical image, a technology for applying image processing to suppress bone tissue on a medical image (bone suppression) has been developed (refer to JP 2012-523889W). A radiologist can easily find a lesion that may be overlooked behind a bone on an original medical image by comparing a processed image obtained by suppressing bone tissue on the medical image with the original image.

When a series of multiple images such as CT images are contained, a display technique of displaying multiple medical images overlaid on one another and switching the images as if the images are sequentially turned according to user's operations is used (stack display). In order not to mix up the first image with the last image in a series of medical images, when operations are conducted using a mouse wheel, an operation to sequentially switch images starting from the first image toward the last images is assigned to rotation moving closer to the user and an operation to sequentially switch images starting from the last image toward the first image is assigned to rotation moving away from the user, for example. When the mouse wheel is rotated in one direction (in a manner that the mouse wheel is rolled closer to the user) to move from the first image toward the last image, the images can be switched back from the last image toward the first image by rotating the mouse wheel in the opposite direction (in a manner that the mouse wheel is rolled away from the user). Similarly, pressing down of two keys such as arrow keys on a keyboard can be assigned to the operation for sequentially switching images from the first image toward the last image and the operation for sequentially switching images from the last image toward the first image.

For diagnosis using a processed image obtained by applying image processing to an original image so that a lesion that cannot be identified owing to the presence of a bone can be identified, the processed image and the original image are alternately displayed at the same position on a screen so that whether or not a lesion is present at the diagnosed site can be determined.

In the related art, however, the operations for switching images in stack display of CT images are also applied to switching between a processed image and an original image. Thus, different operations are assigned to switching from the processed image to the original image and switching from the original image to the processed image. Two types of operations are therefore required for alternately displaying the processed image and the original image, which is low in operability.

### SUMMARY OF THE INVENTION

The present invention has been made in view of the aforementioned drawbacks of the related art, and an object thereof is to improve operability in alternately switching between a processed image and an original image for display.

To achieve at least one of the above-mentioned objects, according to an aspect, an image display apparatus reflecting one aspect of the present invention comprises: a display unit configured to display an original image and a processed image obtained by applying image processing to the original image to allow a lesion that is unidentifiable owing to a bone to be identified; an operation unit configured to receive an operation performed by a user; and a control unit configured to switch display on the display unit to the processed image when one operation at the operation unit is detected in a state in which the original image is displayed on the display unit, and switch the display on the display unit to the original image when the one operation at the operation unit is detected in a state in which the processed image is displayed on the display unit.

According to Item. 2 of the invention, in the image display apparatus of Item. 1, the one operation is preferably rotation of a mouse wheel included in the operation unit in one direction or pressing down of a predetermined key included in the operation unit.

To achieve at least one of the above-mentioned objects, according to an aspect, an image display apparatus reflecting one aspect of the present invention comprises: a display unit configured to display an original image and a processed image obtained by applying image processing to the original image to allow a lesion that is unidentifiable owing to a bone to be identified; and a control unit configured to switch display on the display unit to the processed image when predetermined time has elapsed in a state in which the original image is displayed on the display unit, and switch the display on the display unit to the original image when the predetermined time has elapsed in a state in which the processed image is displayed on the display unit.

To achieve at least one of the above-mentioned objects, according to an aspect, an image display method for an image display apparatus comprising: a display unit configured to display an original image and a processed image obtained by applying image processing to the original image to allow a lesion that is unidentifiable owing to a bone to be identified; and an operation unit configured to receive an operation performed by a user, reflecting one aspect of the present invention comprises: switching display on the display unit to the processed image when one operation at the operation unit is detected in a state in which the original image is displayed on the display unit; and switching the display on the display unit to the original image when the one operation at the operation unit is detected in a state in which the processed image is displayed on the display unit.

To achieve at least one of the above-mentioned objects, according to an aspect, an image display method for an image display apparatus comprising a display unit configured to display an original image and a processed image obtained by applying image processing to the original image to allow a lesion that is unidentifiable owing to a bone to be identified, reflecting one aspect of the present invention comprises: switching display on the display unit to the processed image when predetermined time has elapsed in a state in which the original image is displayed on the display unit; and switching the display on the display unit to the original image when the predetermined time has elapsed in a state in which the processed image is displayed on the display unit.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a system configuration diagram of a medical image system according to a first embodiment of the present invention;

FIG. 2 is a block diagram showing a functional configuration of an image server;

FIG. 3 is an example of a patient information table;

FIG. 4 is an example of an examination information table;

FIG. 5 is an example of a series information table;

FIG. 6 is an example of an image information table;

FIG. 7 is a block diagram showing a functional configuration of a client terminal;

FIG. 8 is a perspective view showing an external appearance of a mouse;

FIG. 9 is a flowchart showing a first medical image display process according to the first embodiment;

FIG. 10 is a flowchart showing the first medical image display process according to the first embodiment;

FIG. 11 is a diagram showing an example of a viewer's screen on which an original image is displayed;

FIG. 12 is a diagram showing an example of a viewer's screen on which a processed image is displayed;

FIG. 13 is a flowchart showing a second medical image display process according to a second embodiment;

FIG. 14 is a diagram showing an example of a viewer's screen when a scaling mode is OFF;

FIG. 15 is a diagram showing an example of a viewer's screen when the scaling mode is ON;

FIG. 16 is a flowchart showing a third medical image display process according to a third embodiment; and

FIG. 17 is a flowchart showing the third medical image display process according to the third embodiment.

### DESCRIPTION OF THE PREFERRED EMBODIMENTS

Hereinafter, an embodiment of the present invention will be described with reference to the drawings. However, the scope of the invention is not limited to the illustrated examples.

### First Embodiment

First, a first embodiment of the present invention will be described.

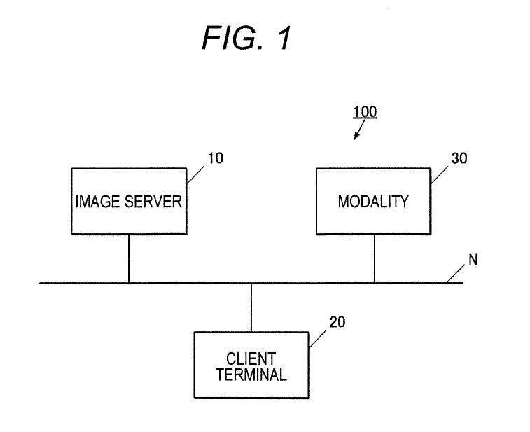

FIG. 1 shows a system configuration of a medical image system 100 according to the first embodiment. As shown in FIG. 1, the medical image system 100 includes an image server 10, a client terminal 20 that is an image display device, and a modality 30, which are connected via a communication network N such as a LAN (Local Area Network) in a manner that the image server 10, the client terminal 20, and the modality 30 can communicate with one another. The DICOM (Digital Imaging and Communications in Medicine) standard is applied to the communication network N.

The image server 10 is a PACS (Picture Archiving and Communication System) configured to save image data and the like of medical images generated by various modalities 30 and provides the image data and the like of medical images in response to a request from an external device such as the client terminal 20.

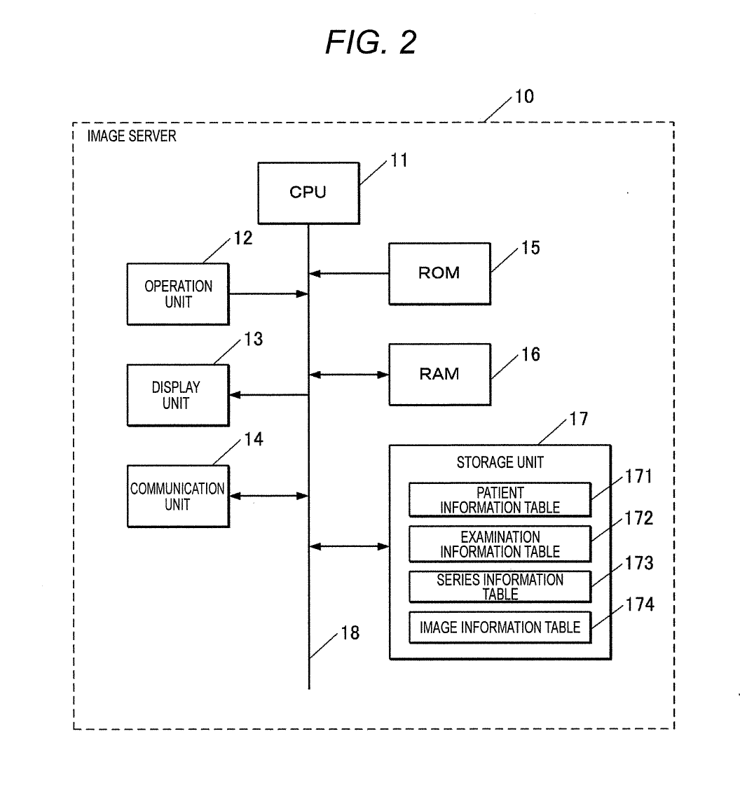

FIG. 2 shows a functional configuration of the image server 10. As show in FIG. 2, the image server 10 includes a CPU (Central Processing Unit) 11, an operation unit 12, a display unit 13, a communication unit 14, a ROM (Read Only Memory) 15, a RAM (Random Access Memory) 16, and a storage unit 17, which are connected via a bus 18.

The CPU 11 generally controls processing operation of the respective components of the image server 10. Specifically, the CPU 11 reads out various processing programs stored in the ROM 15 in response to operation signals input from the operation unit 12 or instruction signals input from the communication unit 14, unpacks the programs in a work area formed in the RAM 16, and performs various processes in cooperation with the programs.

The operation unit 12 includes a keyboard having cursor keys, numeric keys, various function keys, etc. And a pointing device such as a mouse, and is configured to output operation signals input by key operations on the keyboard and mouse operations to the CPU 11.

The display unit 13 is a LCD (Liquid Crystal Display) configured to display various screens on the basis of display data input from the CPU 11.

The communication unit 14 is an interface configured to transmit/receive data to/from external devices such as the client terminal 20.

The ROM 15 is a nonvolatile semiconductor memory or the like and stores control programs and parameters, files, etc., necessary for executing the programs.

The RAM 16 forms a work area for temporarily storing various programs, input or output data, parameters and the like read from the ROM 15 in various processes performed and controlled by the CPU 11.

The storage unit 17 is a hard disk or the like configured to store various data. Specifically, the storage unit 17 stores image data of multiple medical images. The medical images include original images and processed images obtained by applying image processing to the original images so that lesions that cannot be identified owing to the presence of bones can be identified.

The processed images are images obtained by applying bone suppression to suppress bone tissue to medical images. The bone suppression is a process of extracting bone tissue from a medical image and suppressing the bone tissue extracted from the medical image, which is performed for the purpose of improving clarity of tissue other than the bone tissue. A known method can be used for the bone suppression.

The storage unit 17 also stores a patient information table 171, an examination information table 172, a series information table 173, and an image information table 174 for managing associated information of medical images.

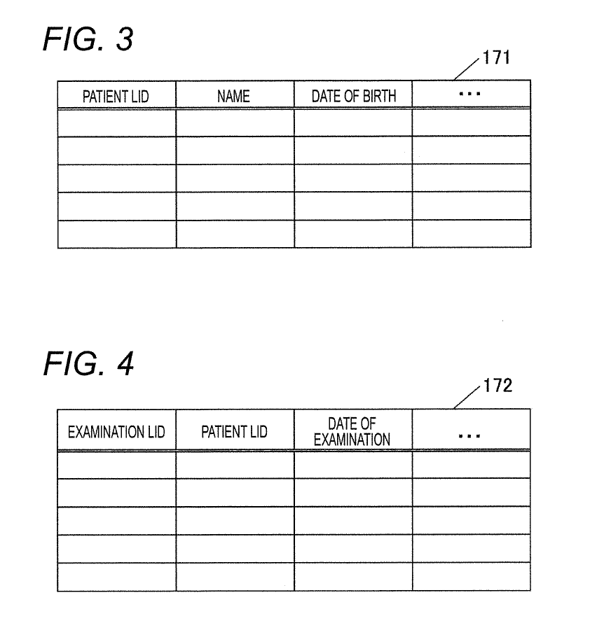

The patient information table 171 is a table for managing data in units of patients. The patient information table 171 stores the name, the date of birth, etc. of a patient in association with each patient LID (Link Identification) as shown in FIG. 3.

The patient LID is identification information of each patient.

The examination information table 172 is a table for managing data in units of examinations. The examination information table 172 stores the patient LID, the date of examination, etc. in association with each examination LID as shown in FIG. 4.

The examination LID is identification information of each examination.

Each patient LID in the examination information table 172 is linked to each patient LID in the patient information table 171, and indicates the patient to which each examination belongs to.

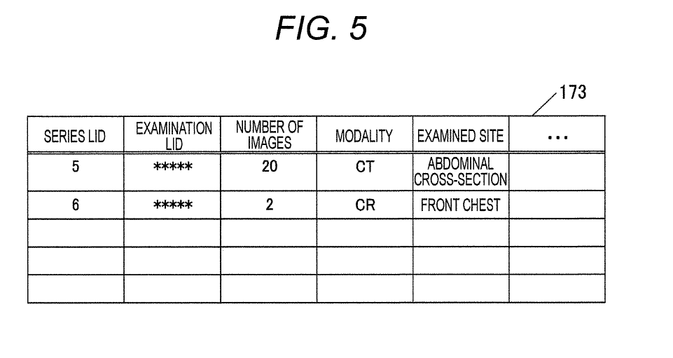

The series information table 173 is a table for managing data in units of series. The series information table 173 stores the examination LID, the number of images, the modality, the examined site, etc. in association with each series LID as shown in FIG. 5.

The series LID is identification information of each series and is a serial number in the series information table 173.

Each examination LID in the series information table 173 is linked to each examination LID in the examination information table 172, and indicates the examination to which each series belongs to.

The number of images is the number of medical images managed by the associated series LID.

The modality is the type of image generation device used for imaging.

The examined site is information indicating the site and the direction of a radiographed patient.

In the example of FIG. 5, the number of images “20”, the modality “CT”, the examined site “abdominal cross-section”, etc. Are associated with the series LID “5”, and the number of images “2”, the modality “CR”, the examined site “front chest”, etc. Are associated with the series LID “6”.

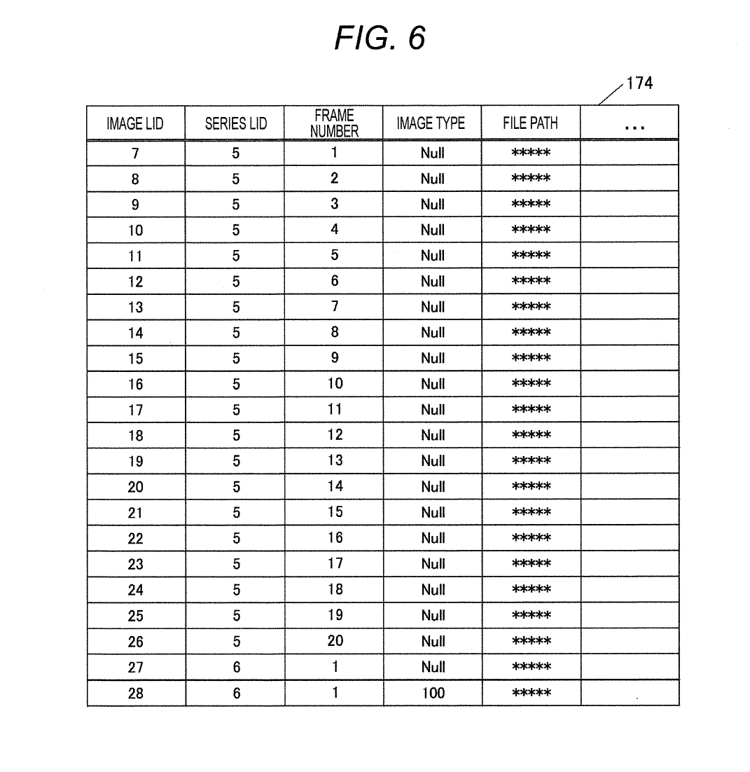

The image information table 174 is a table for managing data in units of images. The image information table 174 stores the series LID, the frame number, the image type, the file path, etc. in association with each image LID as shown in FIG. 6.

The image LID is identification information of each image and is a serial number in the image information table 174.

Each series LID in the image information table 174 is linked to each series LID in the series information table 173, and indicates the series to which each image belongs to.

The frame number is a number that is one of serial numbers in a series.

The image type stores information indicating a special image when the corresponding recorded image is a special image. Specifically, “100” is stored if the corresponding recorded image is a processed image and “Null” is stored otherwise.

The file path is information indicating storage location of the corresponding recorded image.

In the example of FIG. 6, the series LID “5”, the frame numbers “1” to “20”, the image type “Null”, the file paths, etc. Are associated with the image LIDs “7” to “26”. Each of images associated with the image LIDs “7” to “26” is one of a series of 20 abdominal cross-sectional images generated by CT (see FIG. 5).

In addition, the series LID “6”, the frame number “1”, the image type “Null”, the file path, etc. Are associated with the image LID “27”. The image associated with the image LID “27” is a front chest image generated by CR (see FIG. 5).

Furthermore, the series LID “6”, the frame number “1”, the image type “100”, the file path, etc. Are associated with the image LID “28”. Since the image type is “100”, the image associated with the image LID “28” can be determined to be a processed image. In addition, the image associated with the image LID “27” with which the same series LID “6” as the image LID “28” is associated in the image information table 174 can be determined to be an original image corresponding to the processed image with the image LID “28”.

In the present embodiment, although the same series LID as an original image is used for managing a processed image for the sake of convenience, the frame numbers of the image with the image LID “27” and the image with the image LID “28” are not consecutive numbers but are both “1” since the original image and the processed image are not in the same series (simply, two CR images are present).

The CPU 11 acquires an image file of medical images in conformity with the DICOM standard from the modality 30 via the communication unit 14. The image file contains image data of the medical images and a header. The header stores associated information on the medical images. The CPU 11 separates the image file acquired from the modality 30 into the image data (RAW data) of the medical images and the associated information on the medical images, and manages the data and the information separately.

When acquisition of the image data of the medical images or the associated information on the medical images is requested by the client terminal 20, the CPU 11 reads out the requested image data or associated information of the medical images from the storage unit 17 and transmits the read data or information to the client terminal 20.

The client terminal 20 is a device for displaying the medical images on the basis of the image data of the medical images acquired from the image server 10 and interpreting the medical images, and is a PC (Personal Computer) or the like.

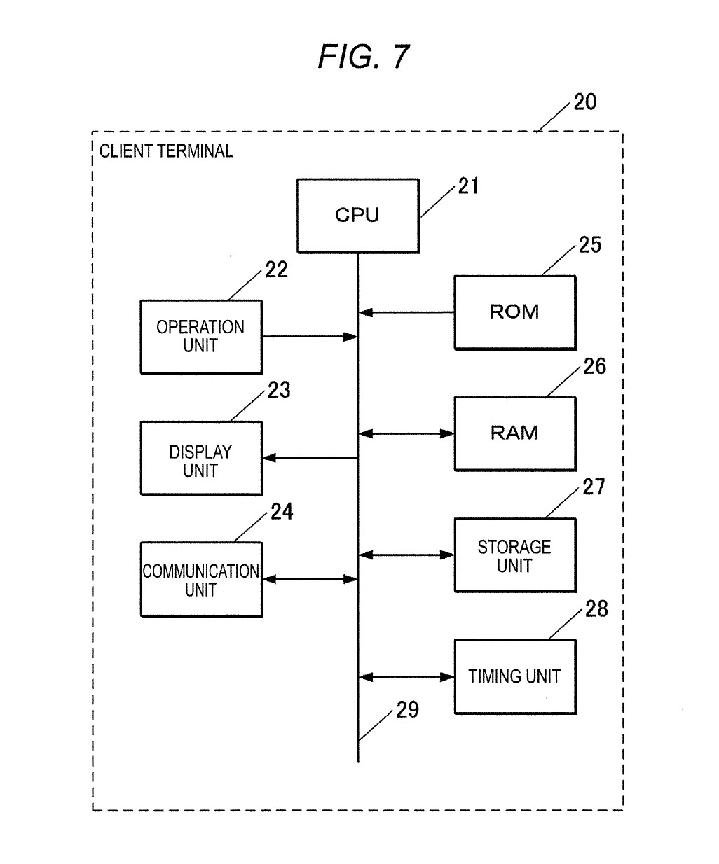

FIG. 7 shows a functional configuration of the client terminal 20. As shown in FIG. 7, the client terminal 20 includes a CPU 21, an operation unit 22, a display unit 23, a communication unit 24, a ROM 25, a RAM 26, a storage unit 27, and a timing unit 28, which are connected via a bus 29.

The CPU 21 generally controls processing operation of the respective components of the client terminal 20. Specifically, the CPU 21 reads out various processing programs stored in the ROM 25 in response to operation signals input from the operation unit 22 or instruction signals input from the communication unit 24, unpacks the programs in a work area formed in the RAM 26, and performs various processes in cooperation with the programs.

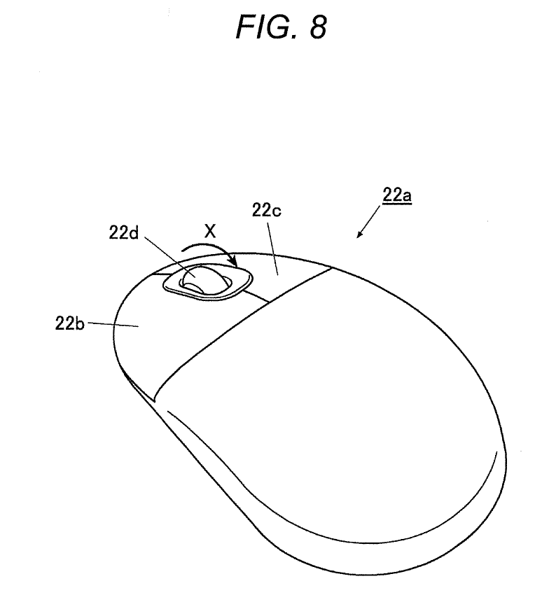

The operation unit 22 is a functional unit configured to receive operational instructions given by the user. The operation unit 22 includes a keyboard having cursor keys, numeric keys, various function keys, etc. And a mouse 22a shown in FIG. 8, and is configured to output operation signals input by key operations on the keyboard and mouse operations to the CPU 21. The mouse 22a is provided with a left button 22b, a right button 22c, and a mouse wheel 22d. The mouse wheel 22d is a rotatable disk-shaped input device that can be rotated in two directions, which are the direction in which the mouse wheel 22d is moved closer to the user (in the direction of an arrow X shown in FIG. 8) and the direction in which the mouse wheel 22d is moved away from the user (in the direction opposite to the arrow X shown in FIG. 8) with fingers placed thereon.

The display unit 23 is a high-definition monitor made of a LCD (Liquid Crystal Display) and configured to display various screens on the basis of display data input from the CPU 21. For example, the display unit 23 displays medical images to be interpreted.

The communication unit 24 is an interface configured to transmit/receive data to/from external devices such as the image server 10.

The ROM 25 is a nonvolatile semiconductor memory or the like and stores control programs and parameters, files, etc., necessary for executing the programs.

The RAM 26 forms a work area for temporarily storing various programs, input or output data, parameters and the like read from the ROM 25 in various processes performed and controlled by the CPU 21. Specifically, the RAM 26 stores image data and the like acquired from the image server 10.

The storage unit 27 is a hard disk or the like configured to store various data.

The timing unit 28 is configured to count time that has elapsed since display of medical images on the display unit 23 is switched.

The CPU 21 transmits a request for acquiring image data of medical images or associated information on the medical images stored in the storage unit 17 to the image server 10 via the communication unit 24, and acquires the image data or associated information of the medical images from the image server 10.

The CPU 21 switches display on the display unit 23 to a processed image when rotation (one operation) of the mouse wheel 22d of the operation unit 22 in the X direction (see FIG. 8) is detected in a state in which an original image is displayed on the display unit 23, and switches the display on the display unit 23 to the original image when rotation of the mouse wheel 22d of the operation unit 22 in the X direction is detected in a state in which the processed image is displayed on the display unit 23.

The modality 30 captures an image of a site to be diagnosed of a patient and converts the captured image into a digital image to generate a medical image. The modality 30 is CR, DR, or CT, for example. The modality 30 writes associated information such as patient information and examination information into the header of an image file of medical images in conformity with the DICOM standard to associate the associated information with the medical images.

Next, operation in the first embodiment will be described.

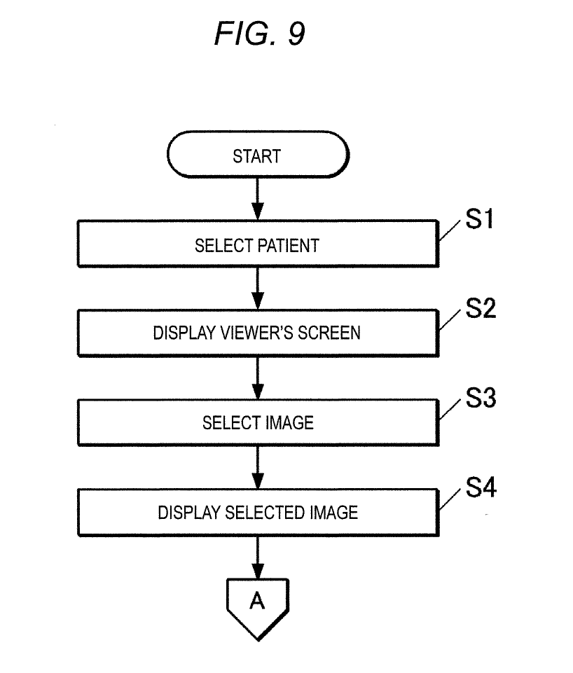

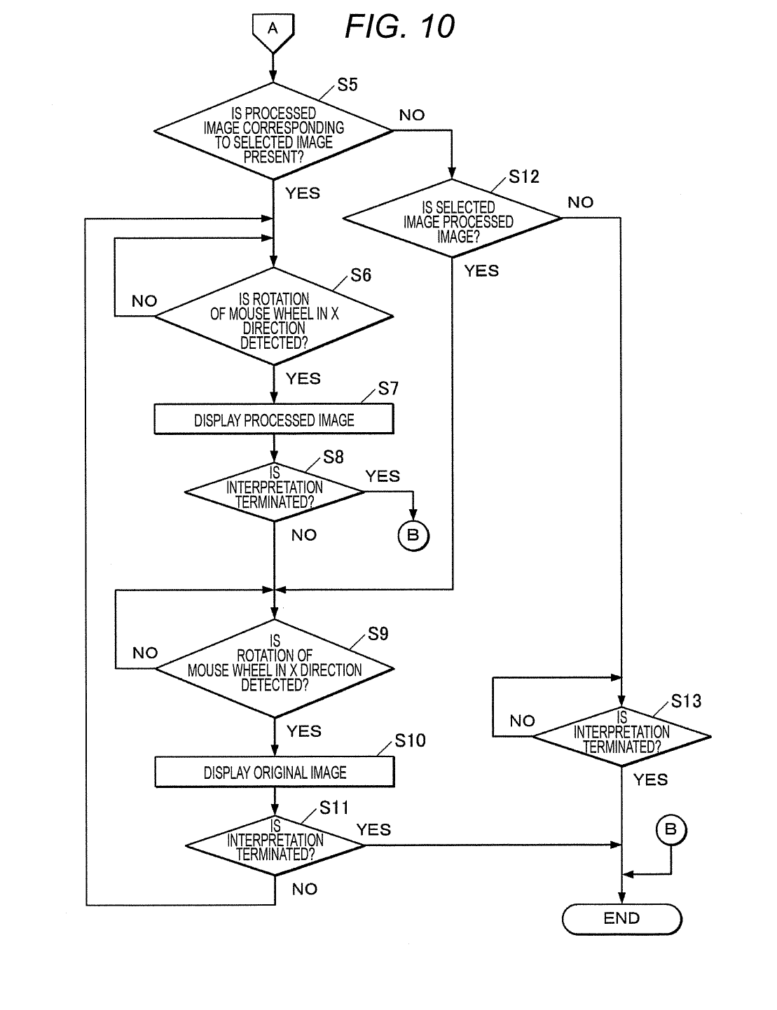

FIGS. 9 and 10 are flowcharts showing a first medical image display process performed by the client terminal 20. This process is realized by software processing in cooperation with the programs stored in the CPU 21 and the ROM 25.

First, a patient subjected to radiography is selected by an operation from the operation unit 22 performed by the user (radiologist) (step S1), and the CPU 21 transmits a request for acquisition of image data of medical images associated with the selected patient to the image server 10 via the communication unit 24.

At the image server 10, when the request for acquisition of the image data of the medical images is received by the communication unit 14, the CPU 11 then reads the image data of the medical images according to the acquisition request from the storage unit 17. Specifically, the CPU 11 acquires the examination LID associated with the patient LID of the patient selected at the client terminal 20 from the examination information table 172, acquires the series LID associated with the acquired examination LID from the series information table 173, and acquires the image LIDs and the file paths of the medical images associated with the acquired series LID from the image information table 174. The CPU 11 then reads the image data of the medical images from the storage unit 17 on the basis of the acquired file paths, and transmits the read image data of the medical images in association with the image LIDs to the client terminal 20 via the communication unit 14.

At the client terminal 20, the CPU 21 acquires the image data of the medical images and the image LIDs from the image server 10 via the communication unit 24. The CPU 21 stores the image data of the medical images and the image LIDs that are acquired in the RAM 26.

Subsequently, the CPU 21 displays a viewer's screen on the display unit 23 on the basis of the acquired image data of the medical images (step S2).

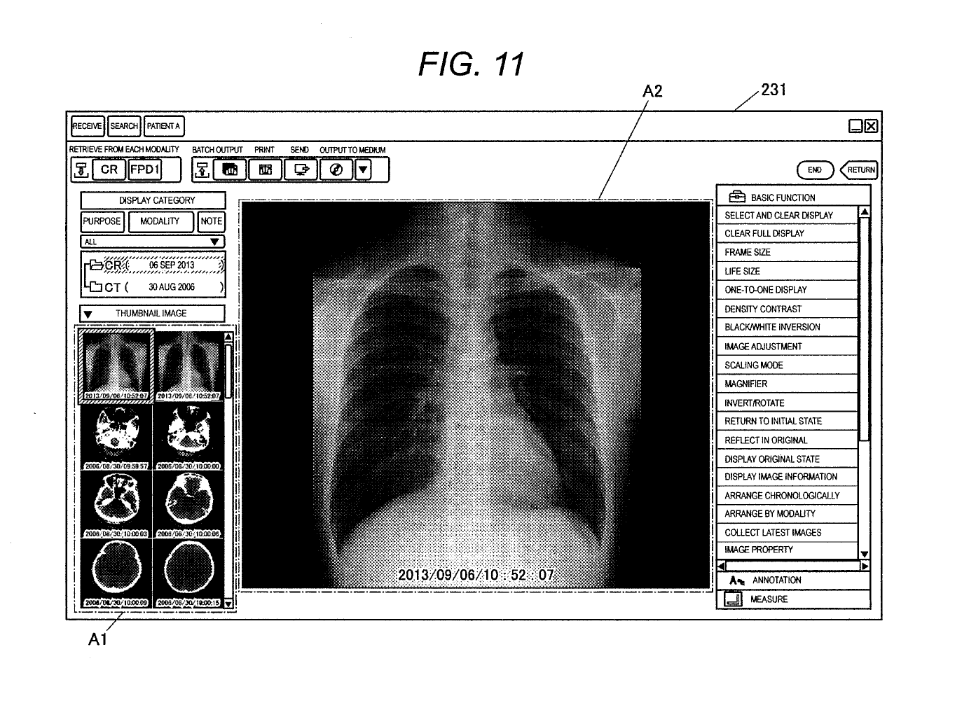

FIG. 11 shows an example of a viewer's screen 231. The viewer's screen 231 contains a thumbnail image display area A1, a selected image display area A2, etc. In the thumbnail image display area A1, thumbnail images of the patient selected in step S1 are displayed. In the selected image display area A2, a medical image selected as an image to be interpreted from the thumbnail images displayed in the thumbnail image display area A1 is displayed.

Subsequently, when any one medical image is selected as an image to be interpreted from the thumbnail images displayed in the thumbnail image display area A1 of the viewer's screen 231 by an operation from the operation unit 22 performed by the user (step S3), the CPU 21 displays the selected medical image in the selected image display area A2 (step S4).

In the selected image display area A2 of the viewer's screen 231 shown in FIG. 11, an original image (medical image before being subjected to bone suppression) of a front chest image is displayed.

Subsequently, referring now to FIG. 10, the CPU 21 determines whether or not a processed image corresponding to the selected image is present, that is, whether or not the selected medical image is an original image (step S5).

Specifically, the CPU 21 transmits an inquiry as to whether or not a processed image corresponding to the selected medical image is present together with the image LID of the selected medical image to the image server 10 via the communication unit 24.

At the image server 10, when the image LID of the selected medical image and the inquiry as to whether or not a processed image corresponding to the selected medical image is present are received by the communication unit 14, the CPU 11 then determines whether or not a record with the same “series LID” as “the series LID associated with the image LID of the selected medical image” and with “the image type” being “100” is present in the image information table 174. If a record with the same “series LID” as “the series LID associated with the image LID of the selected medical image” and with “the image type” being “100” is present, the CPU 11 transmits the image LID associated with the record (the image LID of the processed image) to the client terminal 20 via the communication unit 14.

At the client terminal 20, when the image LID of the processed image is acquired from the image server 10 via the communication unit 24, the CPU 21 determines that the processed image corresponding to the selected medical image is present.

If no record with the same “series LID” as “the series LID associated with the image LID of the selected medical image” and with “the image type” being “100” is present at the image server 10, the CPU 11 transmits information indicating that no processed image corresponding to the selected medical image is present to the client terminal 20 via the communication unit 14.

At the client terminal 20, when the information indicating that not processed image corresponding to the selected medical image is present is acquired from the image server 10 via the communication unit 24, the CPU 21 determines that no processed image corresponding to the selected medical image is present.

If the processed image corresponding to the selected medical image is present (step S5: YES), that is, if the selected medical image is an original image, the CPU 21 determines whether or not rotation of the mouse wheel 22d in the X direction (see FIG. 8) is detected at the mouse 22a of the operation unit 22 (step S6). If the rotation of the mouse wheel 22d in the X direction is not detected (step S6: NO), the process returns to step S6.

If the rotation of the mouse wheel 22d in the X direction is detected in step S6 (step S6: YES), the CPU 21 displays, on the display unit 23, the processed image corresponding to the original image displayed on the display unit 23 on the basis of the image LID of the processed image acquired from the image server 10 (step S7).

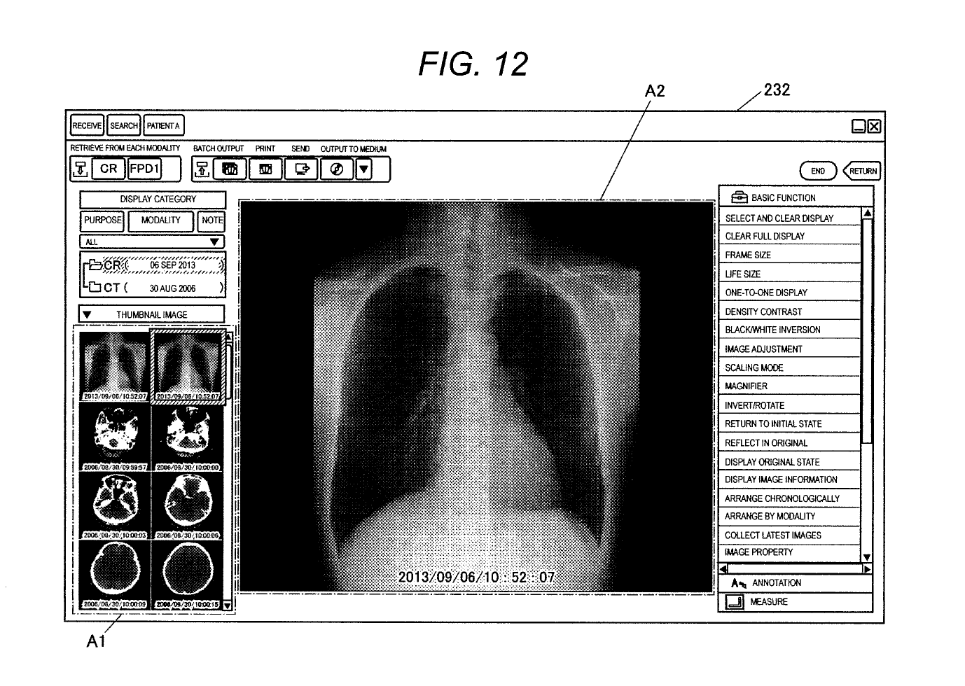

FIG. 12 shows an example of a viewer's screen 232 on which the processed image corresponding to the original image displayed on the viewer's screen 231 in FIG. 11 is displayed. In the selected image display area A2 of the viewer's screen 232, the processed image is displayed.

Here, the CPU 21 determines whether or not an instruction to terminate interpretation is given by an operation from the operation unit 22 performed by the user (step S8). If an instruction to terminate interpretation is not given (step S8: NO), the CPU 21 determines whether or not rotation of the mouse wheel 22d in the X direction is detected at the mouse 22a of the operation unit 22 (step S9). If the rotation of the mouse wheel 22d in the X direction is not detected (step S9: NO), the process returns to step S9.

If the rotation of the mouse wheel 22d in the X direction is detected in step S9 (step S9: YES), the CPU 21 displays, on the display unit 23, the original image corresponding to the processed image displayed on the display unit 23 (step S10).

Specifically, the CPU 21 transmits the image LID of the processed image displayed on the display unit 23 to the image server 10 via the communication unit 24.

At the image server 10, when the image LID of the processed image is received by the communication unit 14, the CPU 11 then acquires the image LID (the image LID of the original image) associated with a record with the same “series LID” as “the series LID associated with the image LID of the processed image” and with “the image type” being “Null” from the image information table 174, and transmits the acquired image LID of the original image to the client terminal 20 via the communication unit 14.

At the client terminal 20, when the image LID of the original image is acquired from the image server 10 via the communication unit 24, the CPU 21 displays the original image corresponding to the processed image on the display unit 23 on the basis of the acquired image LID.

Here, the CPU 21 determines whether or not an instruction to terminate interpretation is given by an operation from the operation unit 22 performed by the user (step S11). If no instruction to terminate interpretation is given (step S11: NO), the process returns to step S6 and the processing is repeated.

If no processed image corresponding to the selected medical image is present in step S5 (step S5: NO), that is, if the selected medical image is not an original image, the CPU 21 determines whether or not the selected medical image is a processed image (step S12).

Specifically, the CPU 21 transmits an inquiry as to whether or not the selected medical image is a processed image together with the image LID associated with the selected medical image to the image server 10 via the communication unit 24.

At the image server 10, when the image LID of the selected medical image and the inquiry as to whether or not the selected medical image is a processed image are received by the communication unit 14, the CPU 11 then acquires “the image type” associated with “the image LID of the selected medical image” from the image information table 174 and transmits the acquired “image type” to the client terminal 20 via the communication unit 14.

At the client terminal 20, the CPU 21 acquires the “image type” associated with the selected medical image from the image server 10 via the communication unit 24 and determines whether or not the acquired “image type” is “100”. The CPU 21 determines that the selected medical image is a processed image when the “image type” is “100”, and determines that the selected medical image is not a processed image if the “image type” is not “100”.

If the selected medical image is a processed image (step S12: YES), the process proceeds to step S9.

If the selected medical image is not a processed image in step S12 (step S12: NO), the CPU 21 determines whether or not an instruction to terminate interpretation is given by an operation from the operation unit 22 performed by the user (step S13). If no instruction to terminate interpretation is given (step S13: NO), the process returns to step S13.

If an instruction to terminate interpretation is given in step S8 (step S8: YES), if an instruction to terminate interpretation is given in step S11 (step S11: YES), or if an instruction to terminate interpretation is given in step S13 (step S13: YES), the first medical image display process is terminated.

As described above, according to the first embodiment, since switching from the original image to the processed image and switching from the processed image to the original image are performed by the same operation for display of the images, the operability in alternately switching between a processed image and an original image for display can be improved.

When a processed image and an original image are displayed, since it is certain that the two images are compared and it is obvious which of the images is a processed image or the original image by looking at the images, the two images can be alternately displayed by repeating a simple operation of rotating the mouse wheel 22d in one direction.

Although a case in which the rotation of the mouse wheel 22d in the X direction is assigned to the operation for switching between a processed image and an original image is described in the first embodiment, rotation of the mouse wheel 22d in the direction opposite to the X direction or pressing down of any one key on the keyboard may be assigned to the operation for switching between a processed image and an original image.

### Second Embodiment

Next, a second embodiment to which the present invention is applied will be described.

Since a medical image system in the second embodiment has a configuration similar to that of the medical image system 100 shown in the first embodiment, FIGS. 1 to 8 are referred to, the configuration is not shown and the description thereof is not repeated. Hereinafter, characteristic features and processing of the second embodiment will be described.

In the second embodiment, a case in which multiple functions are assigned to the rotating operation of the mouse wheel 22d will be described. In the second embodiment, a function of switching between a processed image and an original image by the rotating operation of the mouse wheel 22d and a function of scaling a medical image up or down by the rotating operation of the mouse wheel 22d can be switched.

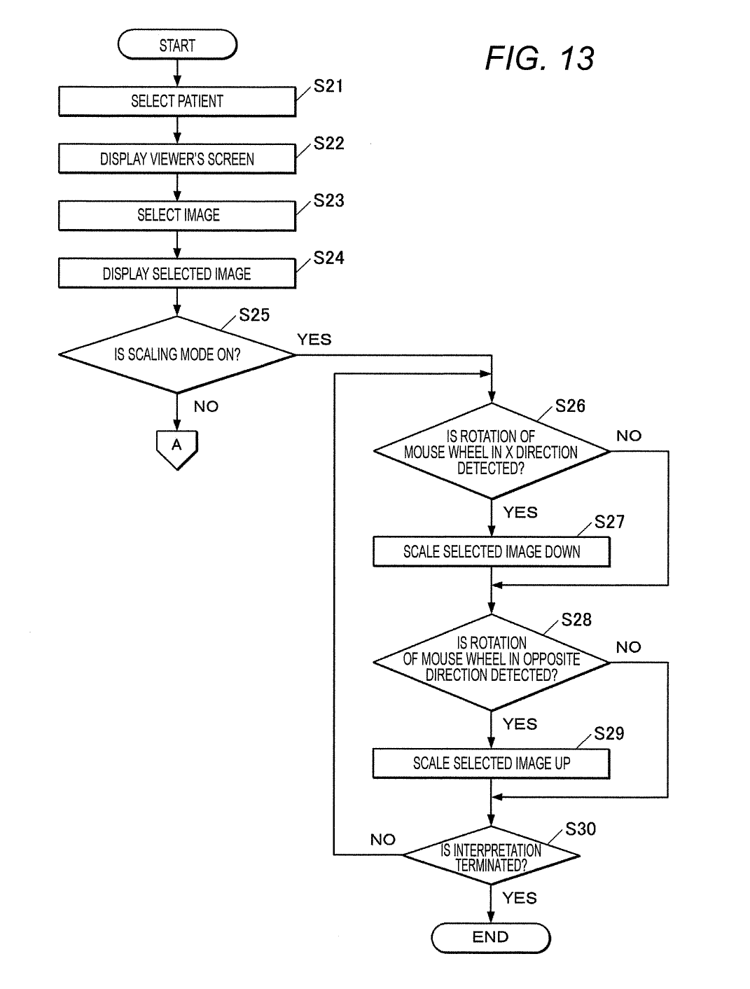

FIGS. 13 and 10 are flowcharts showing a second medical image display process performed by the client terminal 20. This process is realized by software processing in cooperation with the programs stored in the CPU 21 and the ROM 25.

Processing in steps S21 to S24 is the same as that in steps S1 to S4 in the first medical image display process (see FIG. 9), and the description thereof is thus not repeated.

After step S24, the CPU 21 determines whether or not a scaling mode is ON (step S25). If the scaling mode is ON, the function of scaling a medical image up or down is assigned to the rotating operation of the mouse wheel 22d.

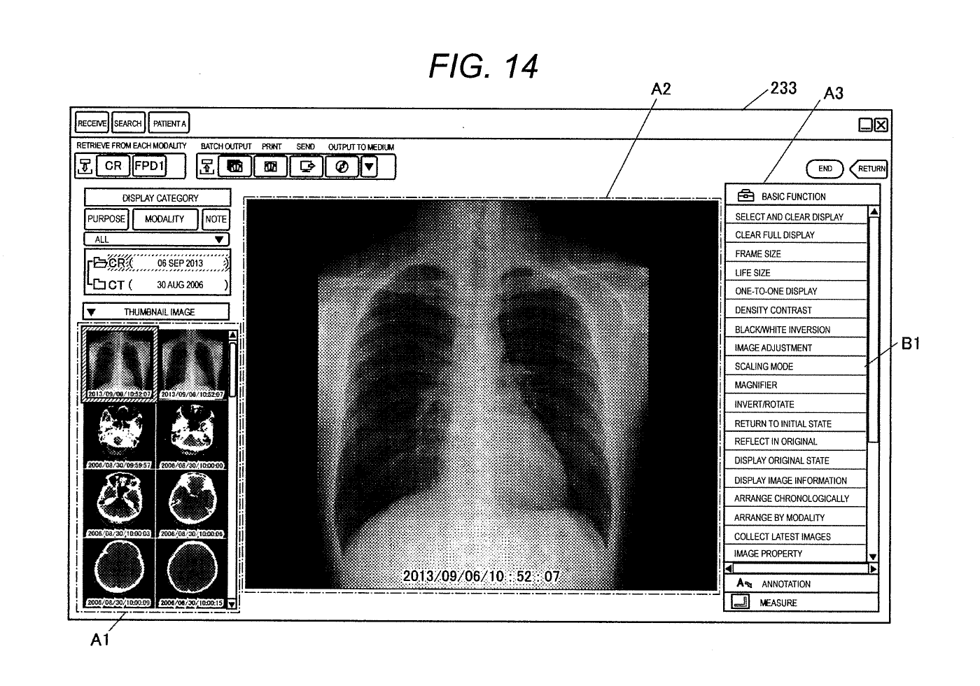

FIG. 14 shows an example of a viewer's screen 233 when the scaling mode is OFF. In the viewer's screen 233, a scaling mode button B1 is not pressed down in a function selection area A3.

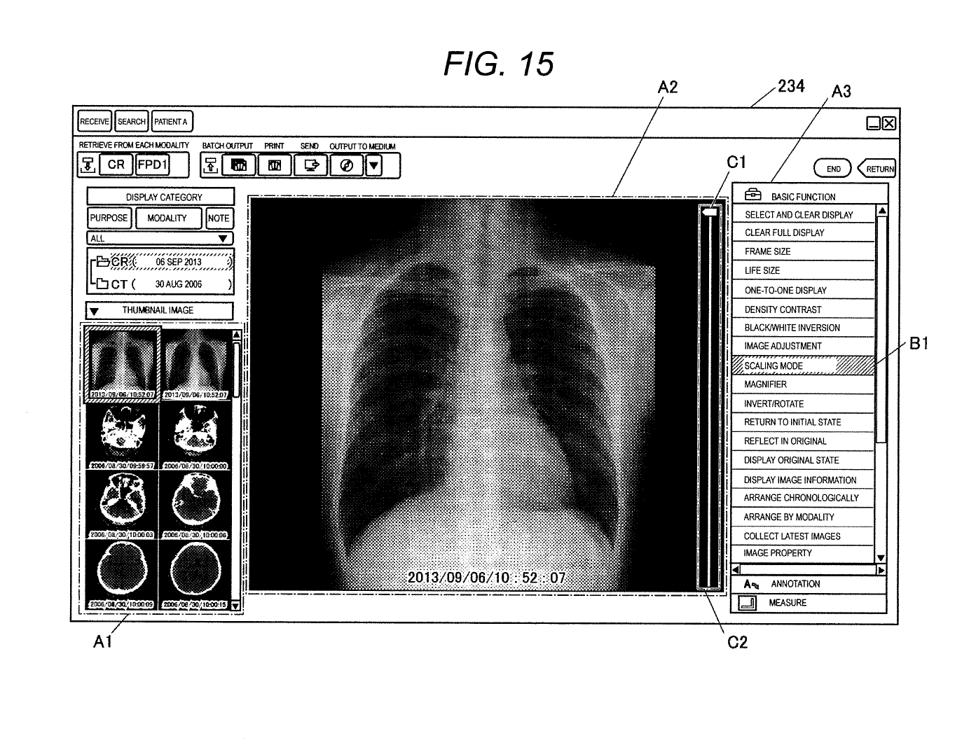

FIG. 15 shows an example of a viewer's screen 234 when the scaling mode is ON. In the viewer's screen 234, the scaling mode button 31 is pressed down in the function selection area A3.

If the scaling mode is not ON (step S25: NO), the process proceeds to step S5 in FIG. 10. Processing in step S5 and subsequent steps is the same as that described in the first medical image display process.

If the scaling mode is ON in step S25 (step S25: YES), the CPU 21 determines whether or not rotation of the mouse wheel 22d in the X direction (see FIG. 8) is detected at the mouse 22a of the operation unit 22 (step S26). If the rotation of the mouse wheel 22d in the X direction is detected (step S26: YES), the CPU 21 scales the selected medical image down and displays the scaled-down medical image on the display unit 23 (step S27).

After step S27 or if rotation of the mouse wheel 22d in the X direction is not detected in step S26 (step S26: NO), the CPU 21 determines whether or not rotation of the mouse wheel 22d in the direction opposite to the X direction is detected at the mouse 22a of the operation unit 22 (step S28). If rotation of the mouse wheel 22d in the direction opposite to the X direction is detected (step S28: YES), the CPU 21 scales the selected medical image up and displays the scaled-up medical image on the display unit 23 (step S29).

After step S29 or if rotation of the mouse wheel 22d in the direction opposite to the X direction is not detected in step S28 (step S28: NO), the CPU 21 determines whether or not an instruction to terminate interpretation is given by an operation from the operation unit 22 performed by the user (step S30). If no instruction to terminate interpretation is given (step S30: NO), the process returns to step S26 and the processing is repeated.

If an instruction to terminate interpretation is given in step S30 (step S30: YES), the second medical image display process is terminated.

Note that switching of display between an original image and a processed image can also be carried out when the scaling mode is ON by moving a pointer C1 shown in FIG. 15 through operation of the operation unit 22. Since an original image and a processed image constitute a set, when the mouse is pressed down at the position of the pointer C1 and then moved down along a scrolling region C2 in a state in which the original image is displayed in the selected image display area A2 as shown in FIG. 15, the position of the pointer C1 jumps to the bottom of the scrolling region C2 at a position lower than the center of the scrolling region C2 and the image displayed in the selected image display area A2 is then switched to the processed image. Furthermore, when the mouse is pressed down at the position of the pointer C1 and then moved up along the scrolling region C2 in a state in which the processed image is displayed in the selected image display area A2, the position of the pointer C1 jumps to the top of the scrolling region C2 at a position higher than the center of the scrolling region C2 and the image displayed in the selected image display area A2 is then switched to the original image.

Alternatively, the pointer C1 may jump to the bottom and the processed image may be displayed when a point in the scrolling region C2 other than the pointer C1 is clicked in a state in which the original image is displayed in the selected image display area A2, and the pointer C1 may jump to the top and the original image may be displayed when a point in the scrolling region C2 is clicked again.

As described above, according to the second embodiment, rotation of the mouse wheel 22d can be assigned to either of the operation for switching between a processed image and an original image and the operation for instructing to scale a medical image up/down.

Although a case in which the rotation of the mouse wheel 22d in one direction is assigned to the operation for switching between a processed image and an original image when the scaling mode is OFF is described in the second embodiment, pressing down of any one key on the keyboard may be assigned to the operation for switching between a processed image and an original image.

### Third Embodiment

Next, a third embodiment to which the present invention is applied will be described.

Since a medical image system in the third embodiment has a configuration similar to that of the medical image system 100 shown in the first embodiment, FIGS. 1 to 7 are referred to, the configuration is not shown and the description thereof is not repeated. Hereinafter, characteristic features and processing of the third embodiment will be described.

The CPU 21 switches the display on the display unit 23 to a processed image when a predetermined time has elapsed in a state in which an original image is displayed on the display unit 23, and switches the display on the display unit 23 to the original image when a predetermined time has elapsed in a state in which the processed image is displayed on the display unit 23.

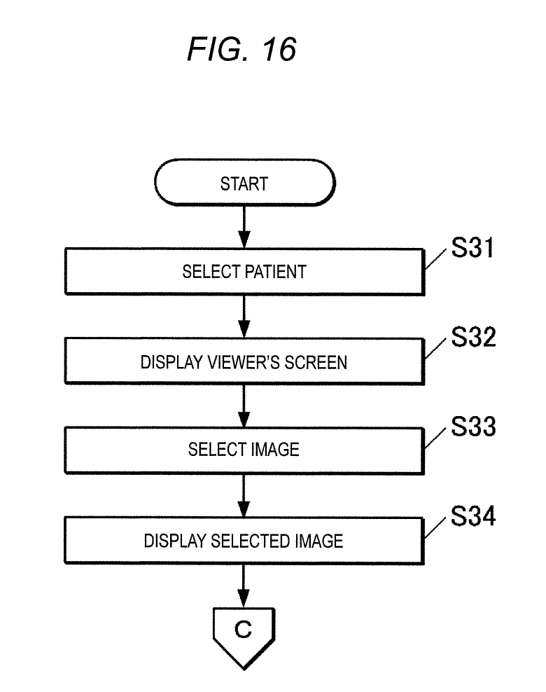

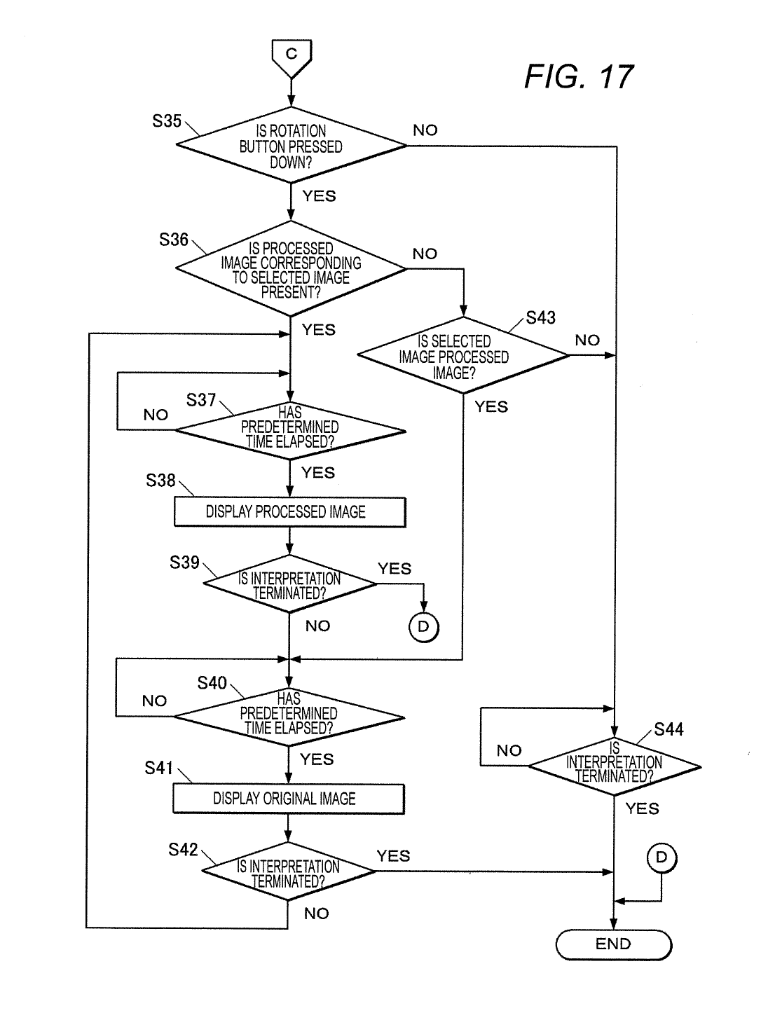

FIGS. 16 and 17 are flowcharts showing a third medical image display process performed by the client terminal 20. This process is realized by software processing in cooperation with the programs stored in the CPU 21 and the ROM 25.

Processing in steps S31 to S34 is the same as that in steps S1 to S4 in the first medical image display process (see FIG. 9), and the description thereof is thus not repeated. In step S34, the timing unit 28 starts counting new elapsed time at a point when display of the selected medical image on the display unit 23 is started.

After step S34, referring now to FIG. 17, the CPU 21 determines whether or not a rotation button (not shown) on the viewer's screen displayed on the display unit 23 is pressed down by an operation from the operation unit 22 performed by the user (step S35). The rotation button is a button for instructing to automatically switch display between an original image and a processed image at predetermined time intervals. When the rotation button is pressed down (step S35: YES), the CPU 21 determines whether or not a processed image corresponding to the selected image is present, that is, whether or not the selected medical image is an original image (step S36). Details of the determination are the same as those in the processing of step S5 in the first medical image display process (see FIG. 10).

If the processed image corresponding to the selected medical image is present (step S36: YES), that is, if the selected medical image is an original image, the CPU 21 acquires the elapsed time from the timing unit 28 and determines whether or not the predetermined time has elapsed since the display on the display unit 23 is switched to the original image (step S37). If the predetermined time has not elapsed since the display is switched to the original image (step S37: NO), the process returns to step S37.

If the predetermined time has elapsed since the display is switched to the original image in step S37 (step S37: YES), the CPU 21 displays, on the display unit 23, the processed image corresponding to the original image displayed on the display unit 23 (step S38). The timing unit 28 starts counting new elapsed time at a point when the display of the processed image on the display unit 23 is started.

Here, the CPU 21 determines whether or not an instruction to terminate interpretation is given by an operation from the operation unit 22 performed by the user (step S39). If no instruction to terminate interpretation is given (step S39: NO), the CPU 21 acquires the elapsed time from the timing unit 28 and determines whether or not the predetermined time has elapsed since the display on the display unit 23 is switched to the processed image (step S40). If the predetermined time has not elapsed since the display is switched to the processed image (step S40: NO), the process returns to step S40.

If the predetermined time has elapsed since the display is switched to the processed image in step S40 (step S40: YES), the CPU 21 displays, on the display unit 23, the original image corresponding to the processed image displayed on the display unit 23 (step S41). The timing unit 28 starts counting new elapsed time at a point when the display of the original image on the display unit 23 is started.

Here, the CPU 21 determines whether or not an instruction to terminate interpretation is given by an operation from the operation unit 22 performed by the user (step S42). If no instruction to terminate interpretation is given (step S42: NO), the process returns to step S37 and the processing is repeated.

If no processed image corresponding to the selected medical image is present in step S36 (step S36: NO), that is, if the selected medical image is not an original image, the CPU 21 determines whether or not the selected medical image is a processed image (step S43). Details of the determination are the same as those in the processing of step S12 in the first medical image display process (see FIG. 10).

If the selected medical image is a processed image (step S43: YES), the process proceeds to step S40.

If the rotation button is not pressed down in step S35 (step S35: NO) or if the selected medical image is not a processed image in step S43 (step S43: NO), the CPU 21 determines whether or not an instruction to terminate interpretation is given by an operation from the operation unit 22 performed by the user (step S44). If no instruction to terminate interpretation is given (step S44: NO), the process returns to step S44.

If an instruction to terminate interpretation is given in step S39 (step S39: YES), if an instruction to terminate interpretation is given in step S42 (step S42: YES), or if an instruction to terminate interpretation is given in step S44 (step S44: YES), the third medical image display process is terminated.

As described above, according to the third embodiment, since switching from the original image to the processed image and switching from the processed image to the original image are performed at predetermined time intervals for display of the images, the operability in alternately switching between a processed image and an original image for display can be improved.

The description of the embodiments above provides examples of the image display apparatus according to the present invention, and the image display apparatus is not limited thereto. Detailed features and detailed operations of respective components included in the apparatus can be modified as appropriate without departing from the gist of the present invention.

Although examples in which a ROM is used as a computer readable medium for storing programs to execute processes are disclosed in the above description, the computer readable medium is not limited thereto. Examples of other computer readable media that can be applied include nonvolatile memories such as flash memory, a portable recording medium such as a CD-ROM. In addition, a carrier wave may be applied as a medium for providing program data via a communication line.

Although the present invention has been described and illustrated in detail, it is clearly understood that the same is by way of illustrated and example only and is not to be taken by way of limitation, the scope of the present invention being interpreted by terms of the appended claims.

What is claimed is:

1. An image display apparatus comprising:
a display unit configured to display an original image and a processed image obtained by applying image processing to the original image to allow a lesion that is unidentifiable owing to a bone to be identified;
an operation unit configured to receive an operation performed by a user; and
a control unit configured to switch display on the display unit to the processed image when one operation at the operation unit is detected in a state in which the original image is displayed on the display unit, and switch the display on the display unit to the original image when the one operation at the operation unit is detected in a state in which the processed image is displayed on the display unit.

2. The image display apparatus according to claim 1, wherein the one operation is rotation of a mouse wheel included in the operation unit in one direction or pressing down of a predetermined key included in the operation unit.

3. An image display apparatus comprising:
a display unit configured to display an original image and a processed image obtained by applying image processing to the original image to allow a lesion that is unidentifiable owing to a bone to be identified; and
a control unit configured to switch display on the display unit to the processed image when predetermined time has elapsed in a state in which the original image is displayed on the display unit, and switch the display on the display unit to the original image when the predetermined time has elapsed in a state in which the processed image is displayed on the display unit.

4. An image display method for an image display apparatus including: a display unit configured to display an original image and a processed image obtained by applying image processing to the original image to allow a lesion that is unidentifiable owing to a bone to be identified; and an operation unit configured to receive an operation performed by a user, the image display method comprising:
switching display on the display unit to the processed image when one operation at the operation unit is detected in a state in which the original image is displayed on the display unit; and
switching the display on the display unit to the original image when the one operation at the operation unit is detected in a state in which the processed image is displayed on the display unit.

5. An image display method for an image display apparatus including a display unit configured to display an original image and a processed image obtained by applying image processing to the original image to allow a lesion that is unidentifiable owing to a bone to be identified, the image display method comprising:
switching display on the display unit to the processed image when predetermined time has elapsed in a state in which the original image is displayed on the display unit; and
switching the display on the display unit to the original image when the predetermined time has elapsed in a state in which the processed image is displayed on the display unit.
